(19) United States
(12) Patent Application Publication
(10) Pub. No.: US 2025/0251094 A1
(43) Pub. Date: Aug. 7, 2025

(54) HOUSING CASE FOR FUEL CONTAINERS AND VEHICLE

(71) Applicant: SUBARU CORPORATION, Tokyo (JP)

(72) Inventor: Aiko HIRAWAKI, Tokyo (JP)

(21) Appl. No.: 19/188,807

(22) Filed: Apr. 24, 2025

Related U.S. Application Data
(63) Continuation of application No. PCT/JP2023/034136, filed on Sep. 20, 2023.

(51) Int. Cl. F17C 13/08; B60K 15/067; B60L 50/72; B62D 21/15

(52) U.S. Cl. CPC F17C 13/084; B60K 15/067; B60L 50/72; B62D 21/155; F17C 2205/0111; F17C 2205/013; F17C 2221/012; F17C 2270/0178; F17C 2270/0184

(57) ABSTRACT

A housing case is configured to house fuel containers that have a cylindrical shape and are spaced apart from each other. The housing case supports each fuel container at three or more points. The housing case includes: a first case having a top surface having a shape where projecting portions and recessed portions are repeated; a second case having a bottom surface having a shape where projecting portions and recessed portions are repeated; and coupling portions where the recessed portions of the first case and the recessed portions of the second case approach each other in a vertical direction. The coupling portions are disposed vertically below an outer edge of the housing case. A distance in the vertical direction between each of the coupling portions and the outer edge increases stepwise from the outer edge toward a center in a lengthwise direction of the housing case.

### CROSS REFERENCE TO RELATED APPLICATIONS

This application is a continuation of International Application No. PCT/JP2023/034136, filed on Sep. 20, 2023, the entire contents of which are hereby incorporated by reference.

### BACKGROUND

The disclosure relates to a housing case for a fuel container, and a vehicle including the housing case.

In recent years, a fuel cell vehicle equipped with a fuel cell has been known as a vehicle mainly intended for emission reduction of environmentally hazardous gas such as carbon dioxide in order to achieve environmental goals such as Sustainable Development Goals (SDGs). Such a vehicle includes fuel containers storing fuel gas (for example, hydrogen gas) in a high-pressure state, supplies the fuel gas filled in the fuel containers to a fuel cell to generate electric energy, and drives a driving source to travel using the electric energy. H ere, in most cases, fuel containers mounted at such a fuel cell vehicle are housed in a housing case in consideration of collision safety.

For example, Japanese Unexamined Patent Application Publication No. 2012-081807 discloses a box-shaped housing case that houses arrayed fuel containers and a coupling member. Each fuel container is formed in a cylindrical shape and includes an opening in at least one end in an axial direction. The coupling member includes a flow path that is coupled to the openings of the fuel containers so as to couple the fuel containers and that allows the insides of the fuel containers to communicate with each other.

### SUMMARY

An aspect of the disclosure provides a housing case configured to house fuel containers. The fuel containers have a cylindrical shape and are spaced apart from each other. The housing case supports each of the fuel containers at three or more points. The housing case includes a first case, a second case, and coupling portions. The first case has a top surface having a shape where projecting portions and recessed portions are repeated. The second case has a bottom surface having a shape where projecting portions and recessed portions are repeated. In the coupling portions, the recessed portions of the first case of the housing case and the recessed portions of the second case of the housing case approach each other in a vertical direction. The coupling portions are disposed vertically below an outer edge of the housing case. A distance in the vertical direction between each of the coupling portions and the outer edge increases stepwise from the outer edge toward a center in a lengthwise direction of the housing case.

An aspect of the disclosure a vehicle including a side frame and the housing case. The housing case includes a protrusion. The protrusion protrudes from the outer edge and being fastened to the side frame.

An aspect of the disclosure a vehicle including a floor panel and a housing space defined by the floor panel and the recessed portions of the first case that faces the floor panel.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a view illustrating a configuration example of a fuel cell vehicle.

FIG. 2 is a view illustrating a configuration example of the fuel cell vehicle.

FIG. 3 is a plan view illustrating a configuration example of a housing case.

FIG. 4 is a cross-sectional view taken along line A-A of FIG. 3.

FIG. 5 is a cross-sectional view illustrating only a first case in a cross section taken along line A-A of FIG. 3.

FIG. 6 is a cross-sectional view illustrating only a second case in the cross section taken along line A-A of FIG. 3.

FIG. 7 is an explanatory view for illustrating a mode in which the housing case is deformed.

FIG. 8 is an explanatory view for illustrating the mode in which the housing case is deformed.

FIG. 9 is an enlarged view of a region E of FIG. 8.

FIG. 10 is an exploded perspective view simply illustrating a configuration example of a housing case according to a second embodiment.

FIG. 11 is an exploded cross-sectional view of the housing case according to the second embodiment.

FIG. 12 is an exploded perspective view simply illustrating a configuration example of a housing case according to a third embodiment.

FIG. 13 is an enlarged cross-sectional view illustrating an enlarged cross-section of a housing case according to a modification.

FIG. 14 is an enlarged cross-sectional view illustrating an enlarged cross-section of a housing case according to a modification.

### DETAILED DESCRIPTION

In general, a large fuel container having a relatively large diameter, which is mounted at, for example, a mass-produced fuel cell vehicle, is designed to have a strength capable of withstanding a high internal pressure. Thus, even when an impact is applied from the outside, for example, at the time of a vehicle collision, a sufficient strength against the impact can be obtained. On the other hand, a small fuel container having a relatively small diameter as described in JP-A No. 2012-081807 is designed to have a thinner wall than a large fuel container because hoop stress (stress applied in a circumferential direction) generated when an internal pressure is applied is smaller than that of the large fuel container. Accordingly, the small fuel container may be insufficient in strength against an impact applied from the outside, for example, at the time of a vehicle collision. Thus, a housing case capable of sufficiently protecting a small fuel container from an impact applied from the outside has been demanded in recent years.

It is desirable to provide a housing case that houses relatively small fuel containers and that can sufficiently protect the fuel containers from an impact, and a vehicle including the housing case.

### 1. EMBODIMENTS

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

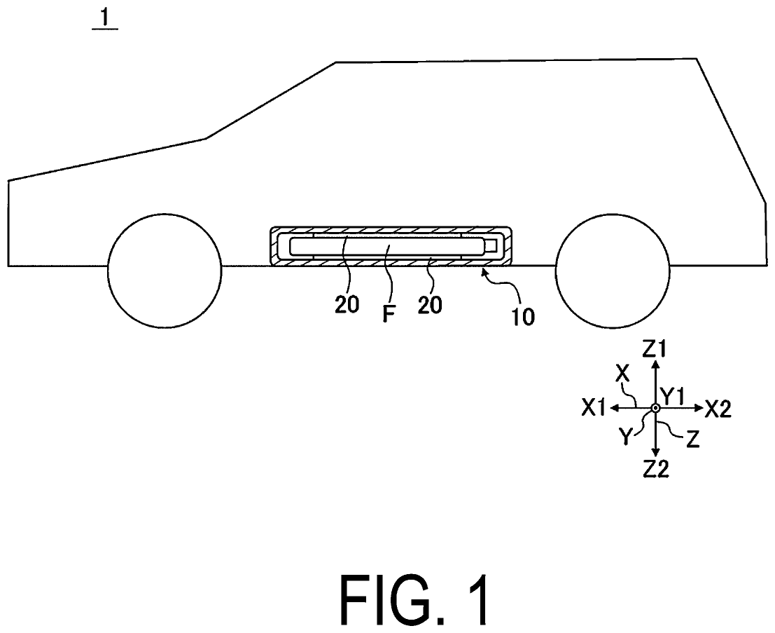

In the following description, an X-axis, a Y-axis, and a Z-axis orthogonal to each other are defined. The X-axis, the Y-axis, and the Z-axis are common in all the drawings (FIGS. 1 to 14) taken as examples in the following description. As illustrated in FIG. 1, a direction along the X-axis when viewed from any point is referred to as a X1 direction, and a direction opposite to the X1 direction is referred to as a X2 direction. Similarly, directions opposite to each other along the Y-axis from any point are referred to as a Y1 direction and a Y2 direction, and directions opposite to each other along the Z-axis from any point are referred to as a Z1 direction and a Z2 direction. An X-Y plane including the X-axis and the Y-axis corresponds to a horizontal plane. The X-axis is an axis along a vehicle length direction of a fuel cell vehicle, and the Y-axis is an axis along a vehicle width direction of the fuel cell vehicle. The Z-axis is an axis along a vertical direction (vehicle height direction). The Z1 direction corresponds to an upward direction in the vertical direction (vertically upward direction), and the Z2 direction corresponds to a downward direction in the vertical direction (vertically downward direction).

A housing case of each embodiment of the disclosure is applied to, for example, a fuel cell vehicle using hydrogen fuel as a power source. Hereinafter, embodiments in which the housing case of the disclosure houses high-pressure hydrogen tanks filled with hydrogen fuel will be described. Each high-pressure hydrogen tank (hereinafter referred to as a hydrogen tank) is a small fuel tank having a relatively smaller diameter than a large fuel container mounted at, for example, a mass-produced fuel cell vehicle. Such a small fuel tank is housed in the housing case in order to be sufficiently protected from an impact applied from the outside, for example, at the time of a vehicle collision.

### First Embodiment

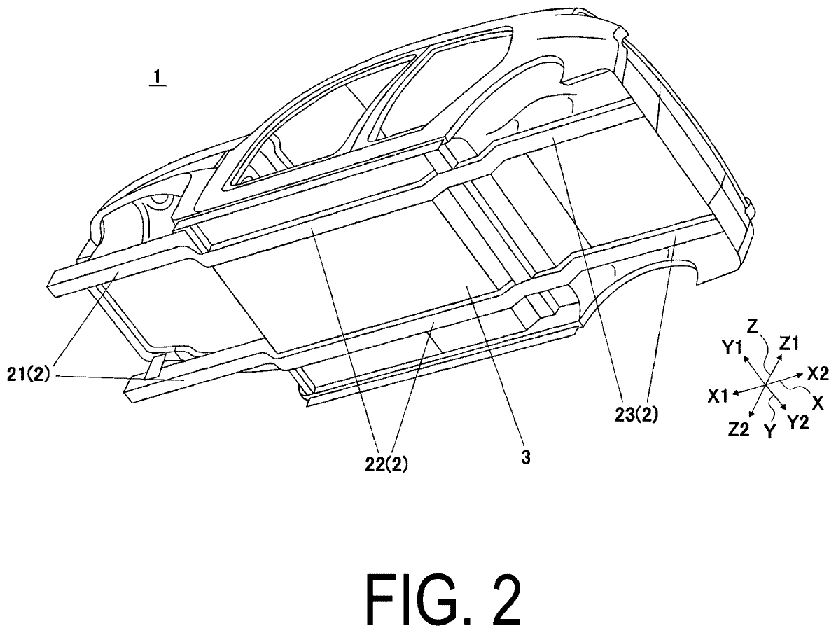

FIGS. 1 and 2 are views illustrating a configuration example of a fuel cell vehicle 1 according to the present embodiment. FIG. 1 is a side view simply illustrating the configuration example of the fuel cell vehicle 1. FIG. 2 is a perspective view partly illustrating an example of a vehicle body frame of the fuel cell vehicle 1. Note that the fuel cell vehicle 1 is an example of a “vehicle”.

The fuel cell vehicle 1 includes side frames 2, a floor panel 3, a housing case 10, and a housing space 25. As illustrated in FIG. 2, the side frames 2 are a pair of frames extending from the front to the rear of the fuel cell vehicle 1, and each side frame 2 includes a front side frame 21, a floor side frame 22, and a rear side frame 23.

The housing case 10 houses cylindrical hydrogen tanks F extending in the X-axis direction and is attached to the fuel cell vehicle 1. In one example, the housing case 10 is fastened to the floor side frames 22 of the side frames 2. The housing space 25 will be described below.

### Configuration of Housing Case

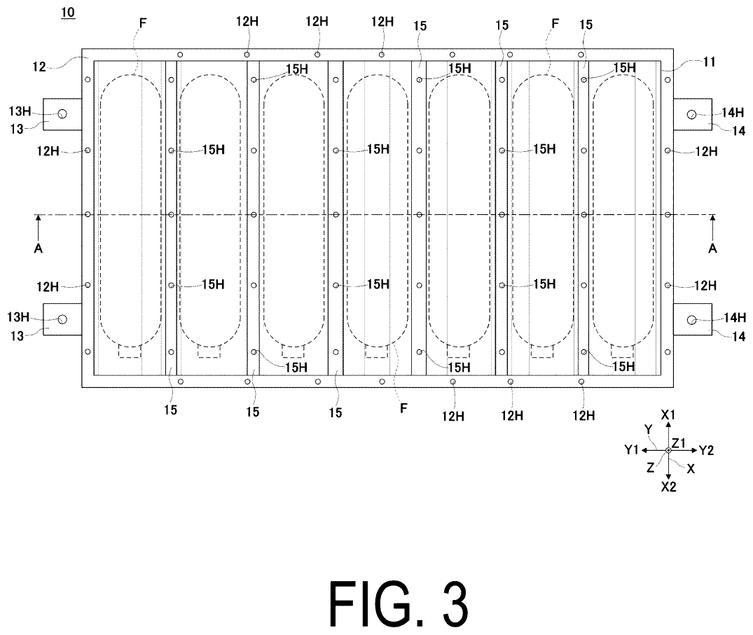

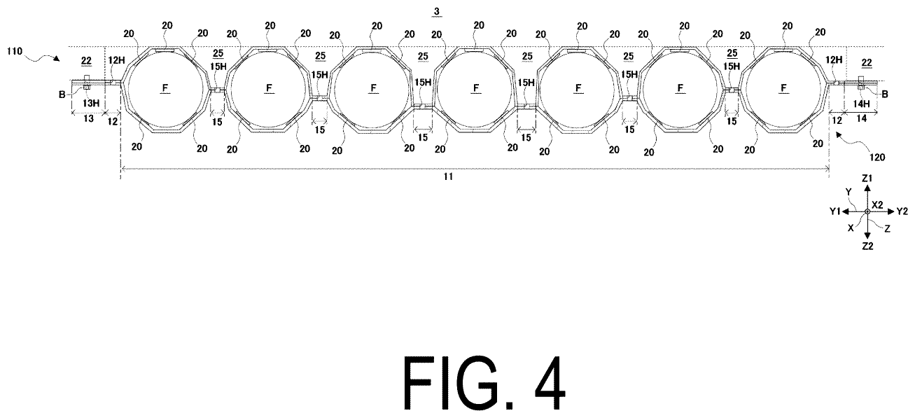

FIG. 3 is a plan view illustrating a configuration example of the housing case 10 according to the present embodiment. FIG. 4 is a cross-sectional view taken along line A-A of FIG. 3. As illustrated in FIGS. 3 and 4, the housing case 10 houses the hydrogen tanks F, and the hydrogen tanks F are sealed in the housing case 10. This prevents the hydrogen tanks F from colliding with each other even when an impact is applied to the housing case 10.

The housing case 10 includes a housing case body 11, an outer edge 12, and protrusions 13 and 14. The housing case body 11 includes housing portions 111 and 112 and coupling portions 15. The housing portions 111 and 112 will be described below.

As illustrated in FIG. 4, the coupling portions 15 are disposed vertically below the outer edge 12 when the housing case 10 is viewed in the X1 direction. In some embodiments, as illustrated in FIG. 4, the distance in the vertical direction between each of the coupling portions 15 and the outer edge 12 increases stepwise from the outer edge 12 toward the center in the Y-axis direction. However, the position of each of the coupling portions 15 in the vertical direction is not particularly limited as long as it is vertically below the outer edge 12.

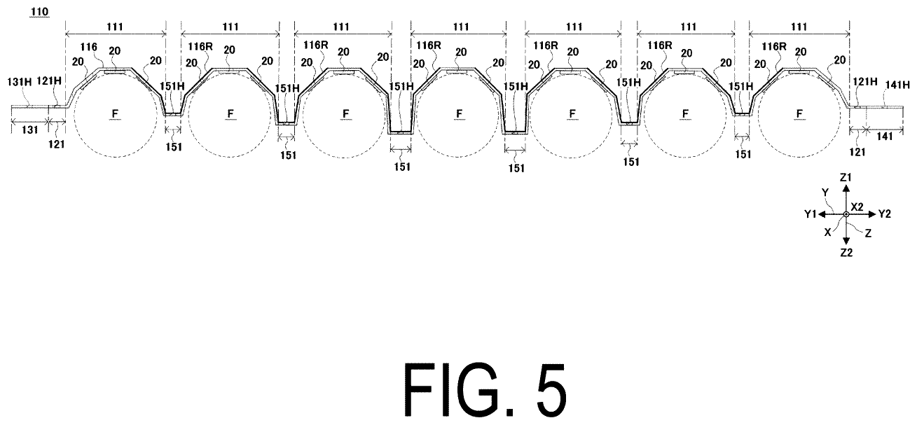

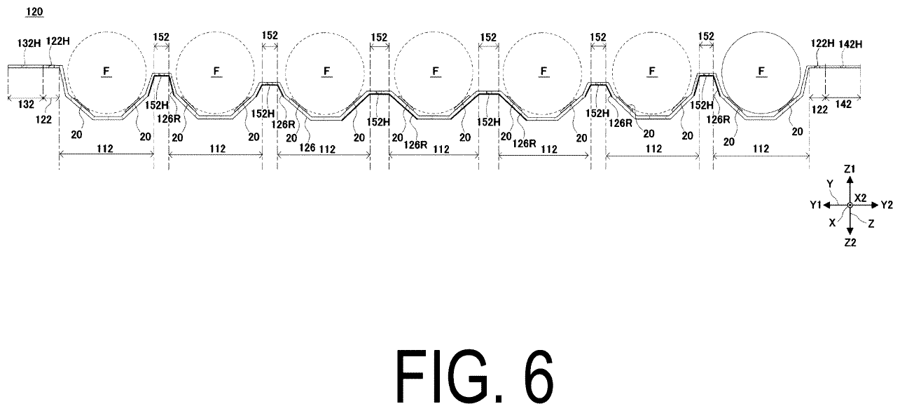

As illustrated in FIG. 3, each coupling portion 15 includes fastening holes 15H. As illustrated in FIG. 3, the fastening holes 15H are provided at intervals in the X-axis direction. The coupling portions 15 are portions at which recessed portions 116R (thick solid lines in FIG. 5) of a below-described first case 110 of the housing case 10 and recessed portions 126R (thick solid lines in FIG. 6) of a below-described second case 120 of the housing case 10 approach each other in the Z-axis direction.

As illustrated in FIG. 3, the outer edge 12 is a rib that surrounds the periphery of the housing case body 11 around the Z-axis and protrudes from the periphery. The outer edge 12 includes fastening holes 12H. As illustrated in FIG. 3, the fastening holes 12H are provided at intervals in the X-axis direction and the Y-axis direction.

As illustrated in FIGS. 3 and 4, the protrusions 13 protrude from the outer edge 12 in the Y1 direction, and each protrusion 13 includes a fastening hole 13H. Similarly, as illustrated in FIGS. 3 and 4, the protrusions 14 protrude from the outer edge 12 in the Y2 direction, and each protrusion 14 includes a fastening hole 14H.

As illustrated in FIG. 4, the protrusions 13 and 14 according to the present embodiment are fastened to the floor side frames 22 of the fuel cell vehicle 1 by bolts B. Here, in the present embodiment, as illustrated in FIG. 4, the housing case 10 is fastened to the floor side frames 22, so that the housing space 25 is formed. The housing space 25 is defined by the floor panel 3 and the recessed portions 116R (see FIG. 5) of the first case 110 facing the floor panel 3.

Since the housing space 25 is formed between the floor panel 3 and the housing case 10, for example, a pipe, a harness, or the like can pass through the housing space 25. As a result, the housing case 10 protects the pipe, the harness, or the like (not illustrated) passing through the housing space 25. That is, the housing case 10 according to the present embodiment can not only protect the hydrogen tanks F from an impact but also protect the pipe, the harness, or the like.

As illustrated in FIG. 4, elastic members 20 are interposed between the housing case 10 and each hydrogen tank F. The housing case 10 supports each hydrogen tank F at three or more points via the elastic members 20. As a result, when an impact is applied to the housing case 10 from the outside, movement of each hydrogen tank F is suppressed, and damage to the hydrogen tank F is prevented. Note that the number of the elastic members 20 interposed between the housing case 10 and each hydrogen tank F is not limited to five illustrated in FIG. 4, and is not particularly restricted as long as the number is three or more. That is, the number of the support points at which the housing case 10 supports each hydrogen tank F via the elastic members 20 is not limited to five illustrated in FIG. 4, and is not particularly restricted as long as the number is three or more.

The housing case 10 according to the present embodiment includes the first case 110 and the second case 120. The first case 110 and the second case 120 are separate bodies. The first case 110 and the second case 120 are fastened to each other with fastening members (not illustrated) that penetrate the fastening holes 15H of the coupling portions 15 and the fastening holes 12H of the outer edge 12. This prevents the first case 110 and the second case 120 from being separated from each other when an impact is applied to the housing case 10 from the outside, and prevents the hydrogen tanks F from slipping down from the housing case 10. Note that the fastening members are not particularly limited and are typically bolts.

Next, the first case 110 and the second case 120 will be described in detail.

### First Case

FIG. 5 is a cross-sectional view illustrating only the first case 110 in the cross section taken along line A-A of FIG. 3. The first case 110 includes the housing portions 111, a rib 121, coupling portions 151, protrusions 131 and 141, and a top surface 116.

The housing portions 111 extend in the X-axis direction and are provided at intervals in the Y-axis direction. As illustrated in FIG. 5, the cross-sectional shape of each housing portion 111 viewed in the X1 direction is a curved shape projecting in the Z1 direction. As illustrated in FIG. 5, the housing portions 111 cover the respective hydrogen tanks F in the Z2 direction.

Each housing portion 111 includes the elastic members 20. As illustrated in FIG. 5, the elastic members 20 are provided at the inner surface of the housing portion 111. The elastic members 20 extend in the X-axis direction and are formed in a plate shape. The elastic members 20 are not particularly limited and are, for example, rubber.

The coupling portions 151 extend in the X-axis direction and are provided at intervals in the Y-axis direction. Each coupling portion 151 is provided between corresponding ones of the housing portions 111 adjacent to each other in the Y-axis direction and is permanently affixed to these housing portions. Each coupling portion 151 includes fastening holes 151H. The fastening holes 151H are provided at intervals in the X-axis direction.

As illustrated in FIG. 5, the coupling portions 151 are disposed in the Z2 direction relative to the rib 121. In some embodiments, as illustrated in FIG. 5, the distance in the vertical direction between each of the coupling portions 151 and the rib 121 increases stepwise from the rib 121 toward the center in the Y-axis direction. However, the position of each of the coupling portions 151 in the vertical direction is not particularly limited as long as it is vertically below the rib 121.

The rib 121 surrounds the periphery of the single-piece body of the housing portions 111 and the coupling portions 151 and protrudes from the periphery. The rib 121 includes fastening holes 121H. The fastening holes 121H are provided at intervals in the X-axis direction and the Y-axis direction. The rib 121 is permanently affixed to the single-piece body of the housing portions 111 and the coupling portions 151. That is, the first case 110 is a single-piece body of the housing portions 111, the coupling portions 151, and the rib 121.

As illustrated in FIG. 5, the protrusions 131 protrude from the rib 121 in the Y1 direction, and each protrusion 131 includes a fastening hole 131H. Similarly, as illustrated in FIG. 5, the protrusions 141 protrude from the rib 121 in the Y2 direction, and each protrusion 141 includes a fastening hole 141H.

The top surface 116 is a surface of the first case 110 facing in the Z1 direction. The top surface 116 includes surfaces of the housing portions 111 facing in the Z1 direction and surfaces of the coupling portions 151 facing in the Z1 direction. When the first case 110 is viewed in the X1 direction, the top surface 116 has a shape in which projecting portions and recessed portions are repeated in the Y-axis direction, as illustrated in FIG. 5. Thus, the recessed portions 116R are formed at the top surface 116 at intervals in the Y-axis direction. The recessed portions 116R are surfaces indicated by the thick solid lines of FIG. 5 in the top surface 116.

The material constituting the first case 110 is not particularly limited, and examples thereof include aluminum. Alternatively, the first case 110 may be formed by welding steel plates processed into a predetermined shape.

### Second Case

FIG. 6 is a cross-sectional view illustrating only the second case 120 in the cross section taken along line A-A of FIG. 3. The second case 120 includes housing portions 112, a rib 122, coupling portions 152, protrusions 132 and 142, and a bottom surface 126.

The housing portions 112 extend in the X-axis direction and are provided at intervals in the Y-axis direction. As illustrated in FIG. 6, the cross-sectional shape of each housing portion 112 viewed in the X1 direction is a curved shape projecting in the Z2 direction. As illustrated in the FIG. 6, the housing portions 112 cover the respective hydrogen tanks F in the Z1 direction.

Each housing portion 112 includes the elastic members 20. As illustrated in FIG. 6, the elastic members 20 are provided at the inner surface of the housing portion 112. The elastic members 20 extend in the X-axis direction and are formed in a plate shape. The elastic members 20 are not particularly limited and are, for example, rubber.

The coupling portions 152 extend in the X-axis direction and are provided at intervals in the Y-axis direction. Each coupling portion 152 is provided between corresponding ones of the housing portions 112 adjacent to each other in the Y-axis direction and is permanently affixed to these housing portions. Each coupling portion 152 includes fastening holes 152H. The fastening holes 152H are provided at intervals in the X-axis direction.

The fastening holes 152H communicate with the fastening holes 151H provided in the coupling portions 151 of the first case 110. The fastening holes 152H, together with the fastening holes 151H, constitute the fastening holes 15H. That is, the fastening holes 15H include the fastening holes 151H and the fastening holes 152H.

As illustrated in FIG. 6, the coupling portions 152 are disposed in the Z2 direction relative to the rib 122. In some embodiments, as illustrated in FIG. 6, the distance in the vertical direction between each of the coupling portions 152 and the rib 122 increases stepwise from the rib 122 toward the center in the Y-axis direction. However, the position of each of the coupling portions 152 in the vertical direction is not particularly limited as long as it is vertically below the rib 122.

The coupling portions 152, together with the coupling portions 151 of the first case 110, constitute the coupling portions 15. That is, the coupling portions 15 of the housing case 10 include the coupling portions 151 of the first case 110 and the coupling portions 152 of the second case 120.

The rib 122 surrounds the periphery of the single-piece body of the housing portions 112 and the coupling portions 152 and protrudes from the periphery. The rib 122 includes fastening holes 122H. The fastening holes 122H are provided at intervals in the X-axis direction and the Y-axis direction.

The fastening holes 122H communicate with the fastening holes 121H provided in the rib 121 of the first case 110. The fastening holes 122H, together with the fastening holes 121H, constitute the fastening holes 12H. That is, the fastening holes 12H include the fastening holes 121H and the fastening holes 122H.

The rib 122 is permanently affixed to the single-piece body of the housing portions 112 and the coupling portions 152. That is, the second case 120 is a single-piece body of the housing portions 112, the coupling portions 152, and the rib 122. The rib 122, together with the rib 121 of the first case 110, constitutes the outer edge 12. That is, the outer edge 12 of the housing case 10 includes the rib 121 of the first case 110 and the rib 122 of the second case 120.

As illustrated in FIG. 6, the protrusions 132 protrude from the rib 122 in the Y1 direction, and each protrusion 132 includes a fastening hole 132H. The fastening holes 132H communicate with the fastening holes 131H of the protrusions 131 provided in the first case 110. The fastening holes 132H, together with the fastening holes 131H, constitute the fastening holes 13H. That is, the fastening holes 13H include the fastening holes 131H and the fastening holes 132H.

The protrusions 132, together with the protrusions 131 provided at the first case 110, constitute the protrusions 13. That is, the protrusions 13 of the housing case 10 include the protrusions 131 of the first case 110 and the protrusions 132 of the second case 120.

As illustrated in FIG. 6, the protrusions 142 protrude from the rib 122 in the Y2 direction, and each protrusion 142 includes a fastening hole 142H. The fastening holes 142H communicate with the fastening holes 141H of the protrusions 141 provided in the first case 110. The fastening holes 142H, together with the fastening holes 141H, constitute the fastening holes 14H. That is, the fastening holes 14H include the fastening holes 141H and the fastening holes 142H.

The protrusions 142, together with the protrusions 141 provided at the first case 110, constitute the protrusions 14. That is, the protrusions 14 of the housing case 10 includes the protrusions 141 of the first case 110 and the protrusions 142 of the second case 120.

The bottom surface 126 is a surface of the second case 120 facing in the Z2 direction. The bottom surface 126 includes surfaces of the housing portions 112 facing in the Z2 direction and surfaces of the coupling portions 152 facing in the Z2 direction. When the second case 120 is viewed in the X1 direction, the shape of the bottom surface 126 is a shape in which projecting portions and recessed portions are repeated in the Y-axis direction, as illustrated in FIG. 6. Thus, the recessed portions 126R are formed at the bottom surface 126 at intervals in the Y-axis direction. The recessed portions 126R are surfaces indicated by the thick solid lines in FIG. 6 in the bottom surface 126.

The material constituting the second case 120 is not particularly limited, and examples thereof include aluminum. Alternatively, the second case 120 may be formed by welding steel plates processed into a predetermined shape.

### Deformation of Housing Case

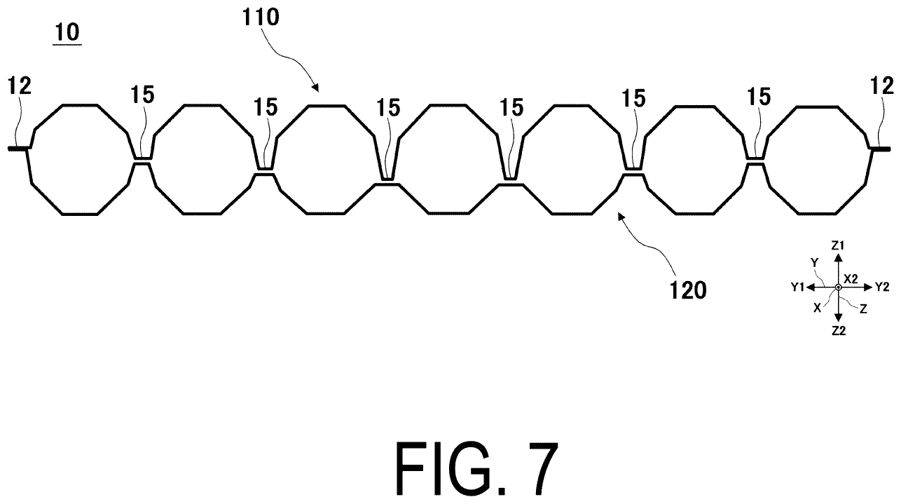

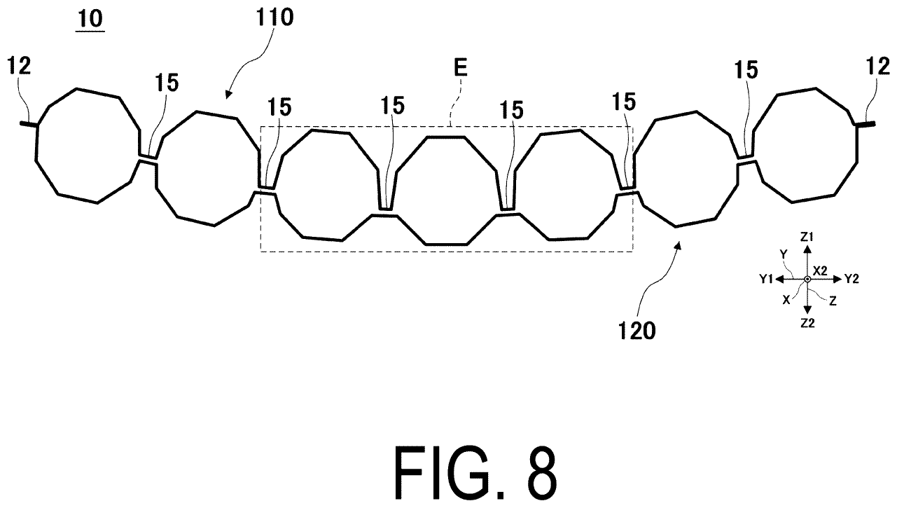

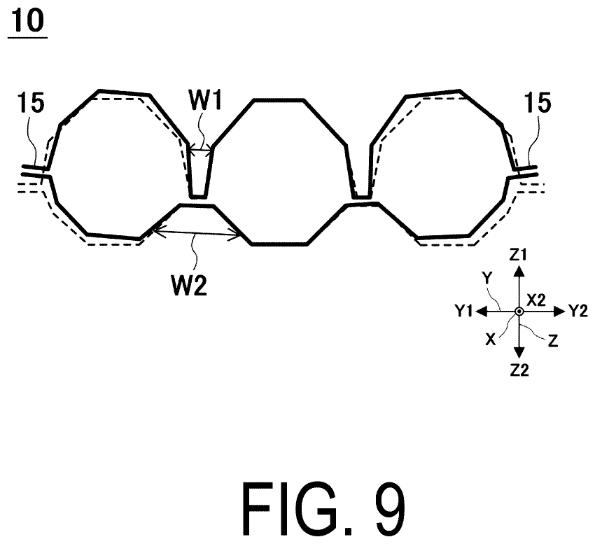

FIGS. 7 and 8 are explanatory views for describing a mode in which the housing case 10 is deformed, and are views simply illustrating the cross section of the housing case 10. FIG. 7 is a view illustrating the housing case 10 before the deformation. FIG. 8 is a view illustrating the housing case 10 after the deformation. FIG. 9 is an enlarged view of a region E of FIG. 8. Note that, in FIGS. 7 to 9, the elastic members 20, the protrusions 13 and 14, and the hydrogen tanks F are omitted.

In the housing case 10 according to the present embodiment, as described above, the coupling portions 15 are disposed vertically below the outer edge 12 (see FIG. 4). Thus, when an impact is applied to the housing case 10 in the Y-axis direction, each interval between corresponding ones of the recessed portions 116R becomes an interval W1 narrower than that before the deformation, and each interval between corresponding ones of the recessed portions 126R becomes an interval W2 wider than that before the deformation, as illustrated in FIG. 9. As a result, as illustrated in FIG. 8, the entire housing case 10 is bent, and the impact applied to the housing case 10 is released in the Z2 direction. That is, since the coupling portions 15 of the housing case 10 are located vertically below the outer edge 12, the impact can be released in the Z2 direction even when the impact is applied in the Y-axis direction. This can suppress the impact applied to the housing case 10 being transmitted to each hydrogen tank F and sufficiently protect each hydrogen tank F from the impact.

### Second Embodiment

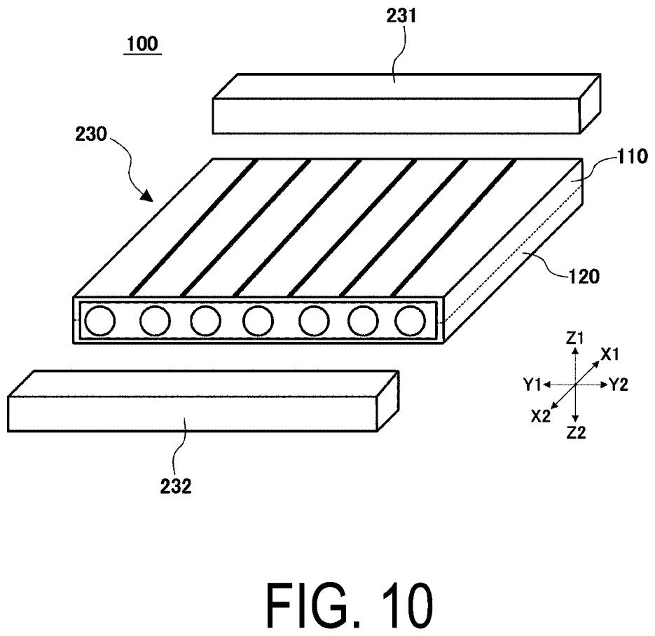

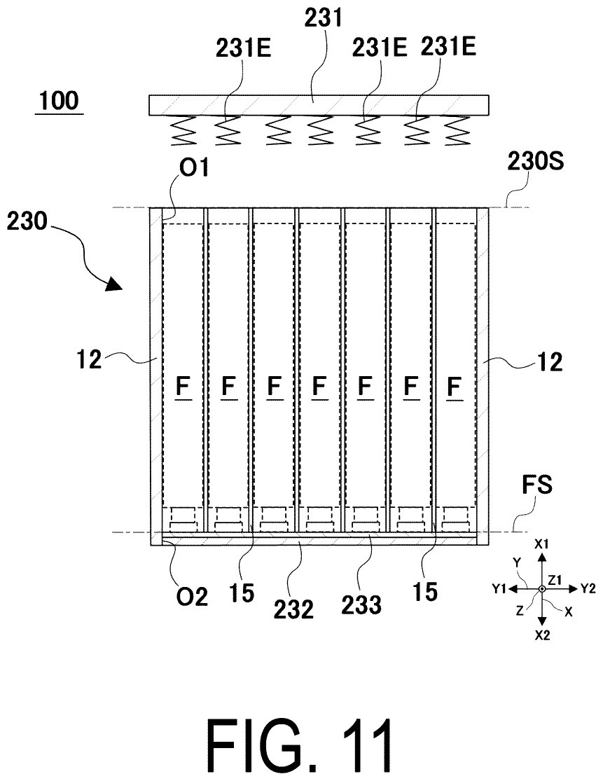

FIG. 10 is an exploded perspective view simply illustrating a configuration example of a housing case 100 according to a second embodiment. FIG. 11 is an exploded cross-sectional view of the housing case 100. Note that, in the following description of the second embodiment, the same configurations as those of the first embodiment are denoted by the same reference signs, and description thereof will be omitted or simplified.

The housing case 100 includes a first case 110 and a second case 120 that are integrally configured or permanently affixed to each other, a single-piece body 230 thereof is opened in the X1 direction and the X2 direction, and the housing case 100 includes first and second sealing members 231 and 232 that close the openings. Except these features, the housing case 100 has the same configuration as the housing case 10 according to the first embodiment. Note that an outer edge 12 and protrusions 13 and 14 are omitted in FIG. 10, and the protrusions 13 and 14 are omitted in FIG. 11.

As illustrated in FIGS. 10 and 11, the housing case 100 includes the single-piece body 230, the first sealing member 231, and the second sealing member 232, and is configured to be dividable into three parts. The first sealing member 231 is a columnar body extending in the Y-axis direction and covers one end of the single-piece body 230 in the lengthwise direction. The first sealing member 231 is provided at an end surface 230S of the single-piece body 230 facing in the X1 direction and closes openings O1. How to join the first sealing member 231 and the single-piece body 230 is not particularly limited, and for example, welding or the like may be employed.

As illustrated in FIG. 11, the first sealing member 231 includes elastic members 231E corresponding to respective hydrogen tanks F. The elastic members 231E urge the hydrogen tanks F in the X2 direction so that end surfaces FS of the hydrogen tanks F are always in contact with a wall 233. This restricts movement of each hydrogen tank F in the X-axis direction. Note that the wall 233 is a plate member for filling the gap between the hydrogen tanks F and the second sealing member 232, but may be omitted as necessary. The elastic members 231E are not particularly limited, but are typically springs.

The second sealing member 232 is a columnar body extending in the Y-axis direction and covers the other end of the single-piece body 230 in the lengthwise direction. The second sealing member 232 closes openings O2 of the single-piece body 230. How to join the second sealing member 232 and the single-piece body 230 is not particularly limited, and for example, welding or the like may be employed.

The first sealing member 231 and the second sealing member 232 cover the single-piece body 230 from both the X1 direction and the X2 direction, thereby sealing the spaces of the single-piece body 230 for housing the respective hydrogen tanks F.

In some embodiments, the first and second sealing members 231 and 232 are made of a flexible material such as hard rubber. As a result, when an impact is applied to the housing case 100 in the Y-axis direction, the first and second sealing members 231 and 232 can be bent following the bending of the single-piece body 230 as illustrated in FIG. 8.

In the housing case 100 according to the second embodiment, each of the coupling portions 15 is disposed vertically below the outer edge 12 in a manner similar to the housing case 10 according to the first embodiment. Thus, as long as the first and second sealing members 231 and 232 are deformable following the deformation of the single-piece body 230, it is possible to obtain the same operational effect as that of the housing case 10 (when an impact is applied, bending vertically downward sufficiently protects each hydrogen tank F from the impact).

### Third Embodiment

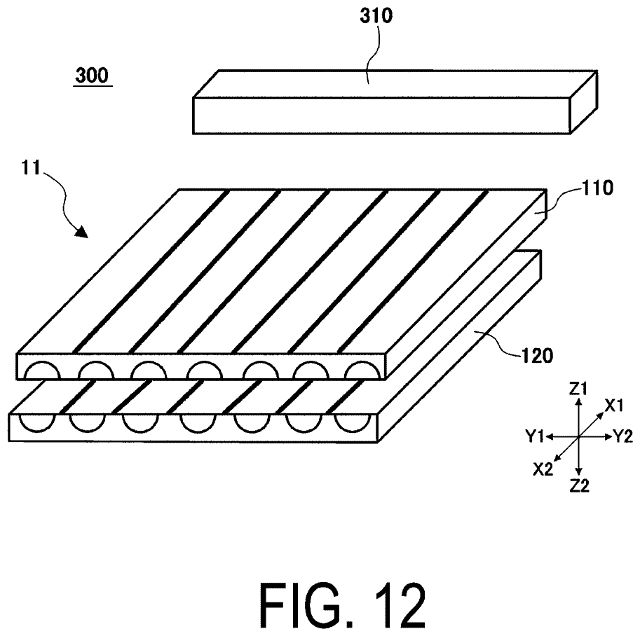

FIG. 12 is an exploded perspective view simply illustrating a configuration example of a housing case 300 according to a third embodiment. In the following description of the third embodiment, the same configurations as those of the first embodiment are denoted by the same reference signs, and description thereof will be omitted or simplified.

In the housing case 300, a housing case body 11 is opened in the X1 direction and the X2 direction, and the housing case 300 includes a columnar member 310 that closes openings in one of these directions. Except these features, the housing case 300 has the same configuration as the housing case 10 according to the first embodiment. Note that, in FIG. 12, an outer edge 12 and protrusions 13 and 14 are omitted.

As illustrated in FIG. 12, the housing case 300 includes cases 110 and 120 that are open in both the X1 and X2 directions and the columnar member 310, and is configured to be dividable into three parts. The columnar member 310 is a columnar body extending in the Y-axis direction and covers the housing case body 11 in the X2 direction. The columnar member 310 is provided at an end surface of the housing case body 11 facing in the X1 direction, and closes the openings on the side in the X1 direction. How to join the housing case body 11 and the columnar member 310 is not particularly limited, and for example, welding or the like may be employed.

In some embodiments, the columnar member 310 is made of a flexible material such as hard rubber. Thus, when an impact is applied to the housing case 300 in the Y-axis direction, the columnar member 310 can be bent following the bending of the housing case body 11 as illustrated in FIG. 8.

In the housing case 300 according to the third embodiment, each of the coupling portions 15 is disposed vertically below the outer edge 12 in a manner similar to the housing case 10 according to the first embodiment. Thus, as long as the columnar member 310 is deformable following the deformation of the housing case body 11, it is possible to obtain the same operational effect as that of the housing case 10 (when an impact is applied, bending vertically downward sufficiently protects each hydrogen tank F from the impact).

### 2. MODIFICATION

Although the embodiments of the disclosure have been described above, the disclosure is not limited to the embodiments described above, and various modifications are possible. Examples of modes of modifications that can be changed from the modes of the above-described embodiments will be described below. Two modes described as examples below may be appropriately combined as long as they do not contradict each other.

### Modification 1

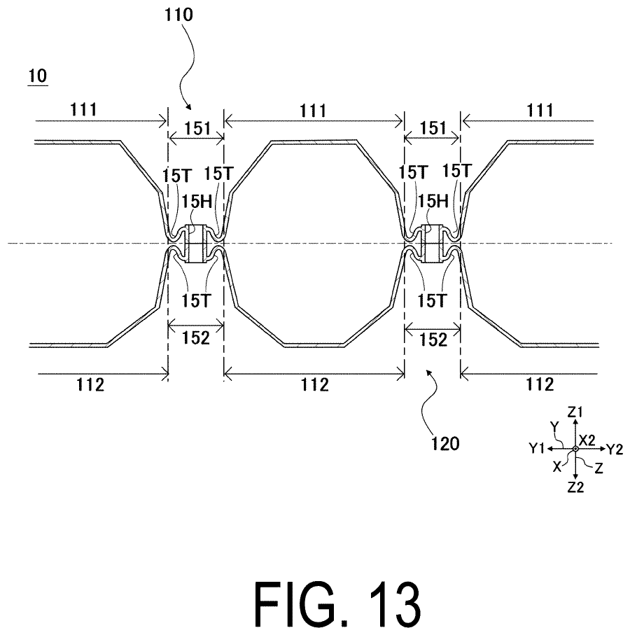

FIG. 13 is an enlarged cross-sectional view illustrating an enlarged cross-section of a housing case 10 according to a modification. In the above embodiments, each coupling portion 15 has a flat shape as illustrated in FIG. 4, but the shape is not limited thereto. For example, as illustrated in FIG. 13, coupling portions 151 may be raised in the Z1 direction and coupling portions 152 may be raised in the Z2 direction. In this case, as illustrated in FIG. 13, each groove 15T extending in the X-axis direction is formed between a corresponding one of fastening holes 15H and a corresponding one of housing portions 111, and between a corresponding one of the fastening holes 15H and a corresponding one of housing portions 112. Accordingly, when an impact is applied to the housing case 10 according to the modification in the Y-axis direction, the housing case 10 is easily bent, and the impact is easily released in the Z2 direction.

### Modification 2

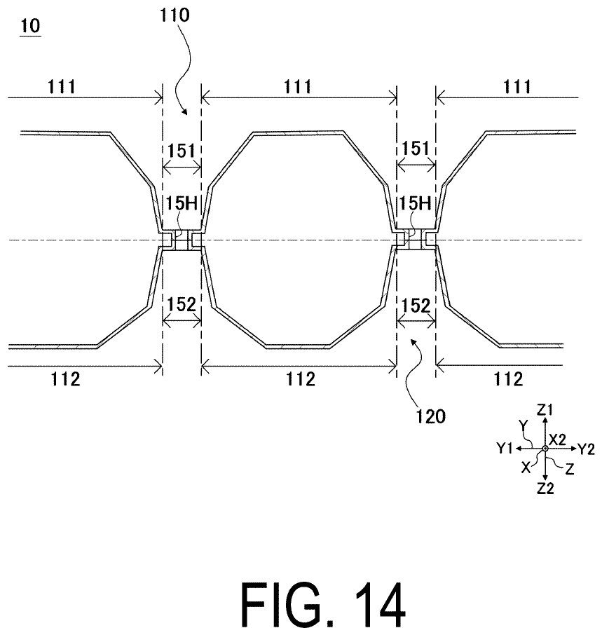

FIG. 14 is an enlarged cross-sectional view illustrating an enlarged cross-section of a housing case 10 according to a modification. In the above embodiments, each coupling portion 15 has a flat shape as illustrated in FIG. 4, but the shape is not limited thereto. For example, as illustrated in FIG. 14, a central portion of each coupling portion 151 in the Y-axis direction may have a shape projecting in the Z2 direction. Similarly, a central portion of each coupling portion 152 in the Y-axis direction may have a shape projecting in the Z1 direction. In this case, the distance between each hydrogen tank F and a corresponding one of housing portions 111 and the distance between each hydrogen tank F and a corresponding one of housing portions 112 are larger than in the case where the coupling portions 15 have a flat shape. Accordingly, in a state where a first case 110 and a second case 120 are fastened to each other, it is possible to suppress an excessive load being applied to each hydrogen tank F from the housing portions 111 and 112.

### 3. SUPPLEMENT

Although the housing case for the fuel containers described as an example in the above embodiments is applied to the fuel cell vehicle, the housing case for the fuel containers of each embodiment of the disclosure may be applied to other than the fuel cell vehicle, and the usage of each embodiment of the disclosure is not particularly limited.

Further, the effects described in the present specification are merely for explanation or exemplification and are not restrictive. That is, each embodiment of the disclosure can achieve other effects that are apparent to those skilled in the art from the description of the present specification, the drawings, and the like, in addition to or instead of the above effects.

Preferred embodiments of the disclosure have been described above in detail with reference to the accompanying drawings, but the technology of the disclosure is not limited to the embodiments. It is apparent to those skilled in the art with common knowledge in the technical field of the disclosure that various variations and modifications may be conceived within the scope of the technical ideas described in the aspects. Thus, it is acknowledged that those variations and modifications are also naturally included in the technical scope of the disclosure.

As described above, according to the disclosure, it is possible to provide a housing case that houses relatively small fuel containers and that can sufficiently protect the fuel containers from an impact, and a vehicle including the housing case.

1. A housing case comprising:
a first case having a top surface having a shape where projecting portions and recessed portions are repeated;
a second case having a bottom surface having a shape where projecting portions and recessed portions are repeated; and
coupling portions being portions where the recessed portions of the first case of the housing case and the recessed portions of the second case of the housing case approach each other in a vertical direction, wherein
the housing case is configured to house fuel containers having a cylindrical shape and being spaced apart from each other,
the housing case supports each of the fuel containers at three or more points,
the coupling portions are disposed vertically below an outer edge of the housing case, and
a distance in the vertical direction between each of the coupling portions and the outer edge increases stepwise from the outer edge toward a center in a lengthwise direction of the housing case.

2. The housing case for fuel containers according to claim 1, wherein
each of the coupling portions has a groove extending in a widthwise direction of the housing case.

3. The housing case for fuel containers according to claim 1, wherein
the first case and the second case are fastened to each other at the coupling portions.

4. The housing case for fuel containers according to claim 1, wherein
the first case and the second case are integrally formed to each other.

5. A vehicle comprising:
a side frame; and
the housing case according to claim 1, the housing case comprising a protrusion, the protrusion protruding from the outer edge and being fastened to the side frame.

6. A vehicle comprising:
a side frame; and
the housing case according to claim 2, the housing case comprising a protrusion, the protrusion protruding from the outer edge and being fastened to the side frame.

7. A vehicle comprising:
a side frame; and
the housing case according to claim 3, the housing case comprising a protrusion, the protrusion protruding from the outer edge and being fastened to the side frame.

8. A vehicle comprising:
a side frame; and
the housing case according to claim 4, the housing case comprising a protrusion, the protrusion protruding from the outer edge and being fastened to the side frame.

9. The vehicle according to claim 5, comprising:
a floor panel; and
a housing space defined by the floor panel and the recessed portions of the first case, the recessed portions of the first case facing the floor panel.

10. The vehicle according to claim 6, comprising:
a floor panel; and
a housing space defined by the floor panel and the recessed portions of the first case, the recessed portions of the first case facing the floor panel.

11. The vehicle according to claim 7, comprising:
a floor panel; and
a housing space defined by the floor panel and the recessed portions of the first case, the recessed portions of the first case facing the floor panel.

12. The vehicle according to claim 8, comprising:
a floor panel; and
a housing space defined by the floor panel and the recessed portions of the first case, the recessed portions of the first case facing the floor panel.
